(19) United States
(12) Patent Application Publication
(10) Pub. No.: US 2024/0037329 A1
(43) Pub. Date: Feb. 1, 2024

(54) COMPUTER-READABLE RECORDING MEDIUM STORING GENERATION PROGRAM, COMPUTER-READABLE RECORDING MEDIUM STORING PREDICTION PROGRAM, AND INFORMATION PROCESSING APPARATUS

(71) Applicant: Fujitsu Limited, Kawasaki-shi (JP)

(72) Inventors: Taiki WATANABE, Yokohama (JP); Tomoya IWAKURA, Kawasaki (JP)

(73) Assignee: Fujitsu Limited, Kawasaki-shi (JP)

(21) Appl. No.: 18/323,694

(22) Filed: May 25, 2023

(30) Foreign Application Priority Data
Jul. 27, 2022 (JP) 2022-119602

(51) Int. Cl. G06F 40/274; G06F 40/279

(52) U.S. Cl. CPC G06F 40/274; G06F 40/279

(57) ABSTRACT

A non-transitory computer-readable recording medium stores a generation program for causing a computer to execute processing including: generating a feature vector of each of a plurality of words based on document data that includes the plurality of words; and generating a feature vector of a compound word obtained by combining two or more words based on the generated feature vector of each of the plurality of words. The feature vector of each of the plurality of words and the feature vector of the compound word are used to predict a word that follows one word in the document data.

### CROSS-REFERENCE TO RELATED APPLICATION

This application is based upon and claims the benefit of priority of the prior Japanese Patent Application No. 2022-119602, filed on Jul. 27, 2022, the entire contents of which are incorporated herein by reference.

### FIELD

The embodiment discussed herein is related to a generation program, a prediction program, an information processing apparatus, a generation method, and a prediction method.

### BACKGROUND

For example, an information extraction technology is used for patent search and document search. The information extraction technology is used to, for example, specify an important word (for example, a person's name or a place name) in document summarization.

Furthermore, in recent years, in order to increase accuracy of information extraction, a language model that predicts a following next word is also used.

Japanese Laid-open Patent Publication No. 2013-20431, Japanese Laid-open Patent Publication No. 2020-77054, Japanese Laid-open Patent Publication No. 2019-219827, and Jacob Devlin, Ming-Wei Chang, Kenton Lee, Kristina Toutanova “Pre-training of Deep Bidirectional Transformers for Language Understanding”, [online], Oct. 11, 2018, arXiv, [retrieved on Jul. 26, 2022], Internet <URL: https://arxiv.org/abs/1810.04805>are disclosed as related art.

### SUMMARY

According to an aspect of the embodiments, a non-transitory computer-readable recording medium stores a generation program for causing a computer to execute processing including: generating a feature vector of each of a plurality of words based on document data that includes the plurality of words; and generating a feature vector of a compound word obtained by combining two or more words based on the generated feature vector of each of the plurality of words. The feature vector of each of the plurality of words and the feature vector of the compound word are used to predict a word that follows one word in the document data.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of an information processing apparatus as an example of an embodiment;

FIG. 2 is a diagram for describing a method of generating a compound word vector by a first multi-word feature processing unit in the information processing apparatus as an example of the embodiment;

FIG. 3 is a diagram exemplifying an inverse language model in the information processing apparatus as an example of the embodiment;

FIG. 4 is a flowchart for describing a method of training a machine learning model in the information processing apparatus as an example of the embodiment; and

FIG. 5 is a diagram exemplifying a hardware configuration of the information processing apparatus as an example of the embodiment.

### DESCRIPTION OF EMBODIMENTS

For example, a language model is trained by using a large-scale text and used for an information extraction task. For example, the language model is trained by performing machine learning to predict the next word from a large amount of unlabeled texts. Then, an internal representation (feature vector) of the language model trained in this way is used for the information extraction task. For example, in the information extraction task, an internal representation corresponding to a word acquired by the language model is used.

However, in such an existing information extraction technology, since each word is predicted by using only a feature vector of each word included in the language model, prediction accuracy is low. For example, for a sentence “1732, George Washington . . . ”, “Washington” representing a person's name may be predicted as a place name, and thus the prediction accuracy decreases.

In one aspect, an object of an embodiment is to improve prediction accuracy regarding document data. [0011] Hereinafter, an embodiment of the present generation program, prediction program, information processing apparatus, generation method, and prediction method will be described with reference to the drawings. Note that the embodiment to be described below is merely an example, and there is no intention to exclude application of various modifications and technologies not explicitly described in the embodiment. For example, the present embodiment may be variously modified and performed in a range without departing from the spirit thereof. Furthermore, each drawing is not intended to include only components illustrated in the drawing, and may include another function and the like.

### (A) Configuration

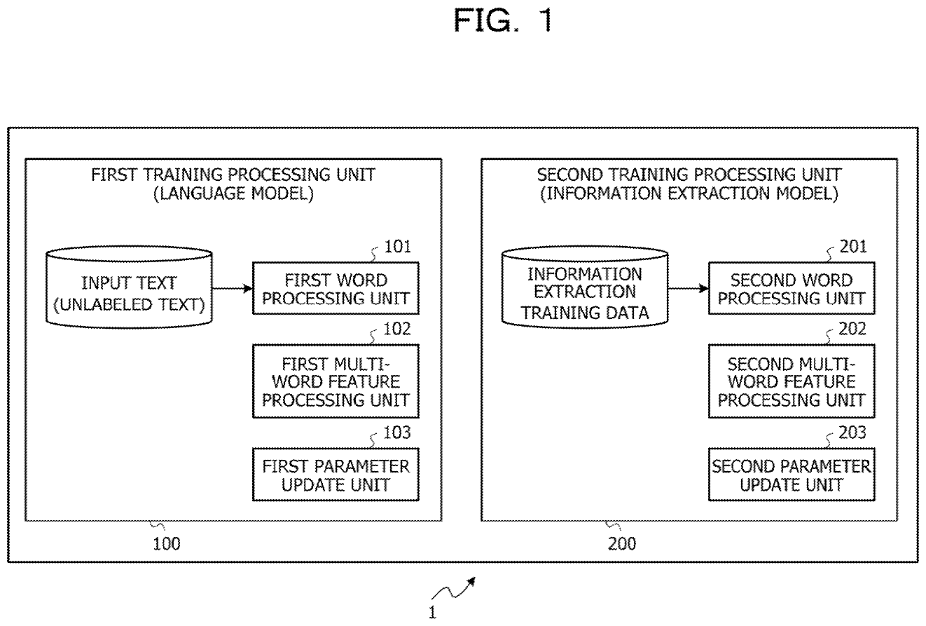

FIG. 1 is a diagram schematically illustrating a configuration of an information processing apparatus 1 as an example of the embodiment.

The information processing apparatus 1 exemplified in FIG. 1 includes a first training processing unit 100 and a second training processing unit 200.

The first training processing unit 100 performs training (machine learning) of a language model.

The language model is a machine learning model that predicts (estimates), for a word in a text (document data), a (next) word following the word. The language model may be referred to as a preliminary training model.

As illustrated in FIG. 1, the first training processing unit 100 includes a first word processing unit 101, a first multi-word feature processing unit 102, and a first parameter update unit 103.

A text (unlabeled text) is input to the first word processing unit 101. The text is document data including a plurality of words. The text input to the first training processing unit 100 may be referred to as an input text. The input text may be referred to as first training data.

The first word processing unit 101 sequentially predicts a word following each word by sequentially inputting a plurality of words constituting the input text to the language model.

The first word processing unit 101 vectorizes each predicted word by using, for example, a long short-term memory (LSTM) network. Hereinafter, a value of the vectorized word may be referred to as a feature vector. Furthermore, the feature vector may be referred to as an internal state, and vectorization of a word by using the LSTM network or the like may be referred to as construction of the internal state corresponding to the word. A method of vectorizing a word is not limited to the LSTM network, and may be appropriately changed and performed by using a known method.

The first multi-word feature processing unit 102 calculates a feature vector of a compound word obtained by combining a plurality of consecutive words in the text based on a feature vector obtained by vectorizing each word calculated by the first word processing unit 101.

The first multi-word feature processing unit 102 selects a plurality of consecutive words (hereinafter, referred to as a plurality of words or a compound word), and generates one feature vector by using a convolutional neural network (CNN) from the respective feature vectors of these plurality of words. Hereinafter, the feature vector generated based on the plurality of words may be referred to as a compound word vector. Furthermore, hereinafter, generating the compound word vector based on the plurality of words may be represented as constructing an internal state of the compound word.

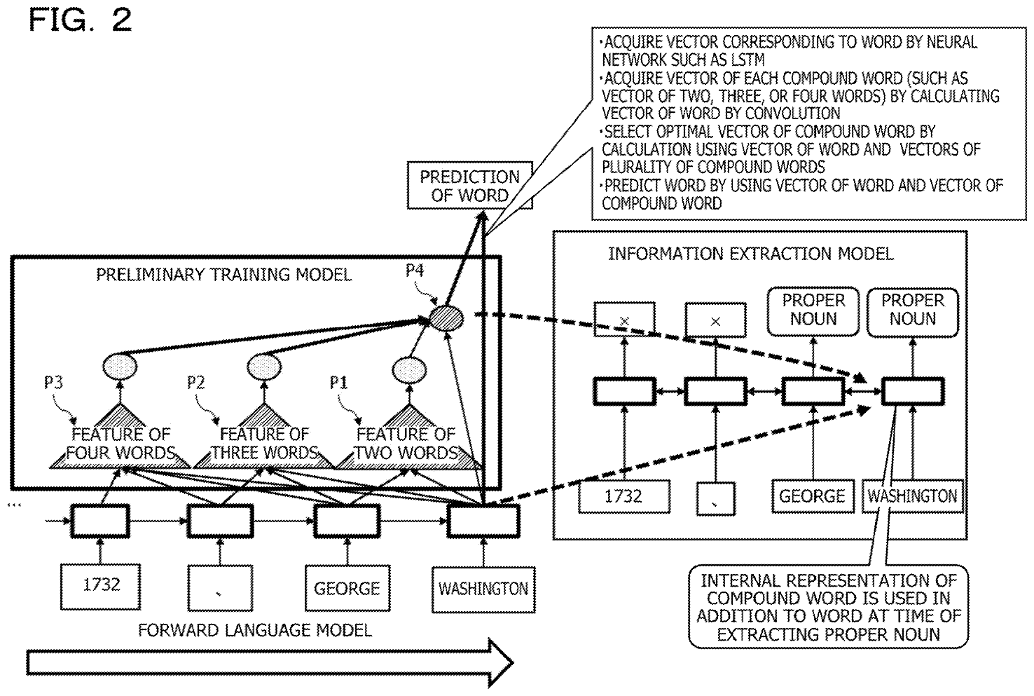

FIG. 2 is a diagram for describing a method of generating the compound word vector by the first multi-word feature processing unit 102 in the information processing apparatus 1 as an example of the embodiment.

FIG. 2 illustrates a forward language model that performs processing on the text (document data) in a forward direction from beginning to end. Furthermore, the first multi-word feature processing unit 102 sequentially selects one word to be processed and performs processing on a plurality of words constituting the text from the beginning to the end of the text. The example illustrated in FIG. 2 illustrates processing in a forward direction mode in which a plurality of words selected in the forward direction from the beginning to the end of the text is combined to generate a compound word vector. Furthermore, hereinafter, the word to be processed among the plurality of words constituting the text may be referred to as a word to be processed.

The first multi-word feature processing unit 102 generates the respective compound word vectors with a plurality of types of the number of words. In the example illustrated in FIG. 2, the first multi-word feature processing unit 102 calculates each of a feature vector of two consecutive words (hereinafter, referred to as two words), a feature vector of three consecutive words (hereinafter, referred to as three words), and a feature vector of four consecutive words (hereinafter, referred to as four words), including the word to be processed. The first multi-word feature processing unit 102 acquires a feature of a proper noun including a plurality of words.

The example illustrated in FIG. 2 illustrates processing performed by the first multi-word feature processing unit 102 on a text “1732, George Washington”. The first multi-word feature processing unit 102 performs the processing on four words of “1732”, “,”, “George”, and “Washington” included in this text in this order, and the example illustrated in FIG. 2 illustrates an example in which Washington is the word to be processed.

The first multi-word feature processing unit 102 calculates a feature vector of two consecutive words (“George” and “Washington”) including “Washington” (see reference sign P1). Furthermore, the first multi-word feature processing unit 102 calculates a feature vector of three consecutive words (“,”, “George”, and “Washington”) including “Washington” (see reference sign P2). Moreover, the first multi-word feature processing unit 102 calculates a feature vector of four consecutive words (“1732”, “,”, “George”, and “Washington”) including “Washington” (see reference sign P3).

Then, the first multi-word feature processing unit 102 obtains an inner product of the calculated compound word vector with each number of words and a feature vector of the word to be processed (see reference sign P4). Hereinafter, a result of this inner product may be referred to as an expanded feature vector of the word to be processed.

In this way, in the first multi-word feature processing unit 102, by obtaining the inner product of the calculated compound word vector with each number of words and the feature vector of the word to be processed, which one of values of the feature vector of two words, the feature vector of three words, and the feature vector of four words is valid is represented by probability (weight, importance level).

It may be said that a value of the expanded feature vector reflects the feature vector of the word to be processed and reflects information regarding the plurality of words (compound word vector) including the word to be processed.

Furthermore, although the forward language model is illustrated in FIG. 2 for convenience, a bidirectional language model is used in the first multi-word feature processing unit 102.

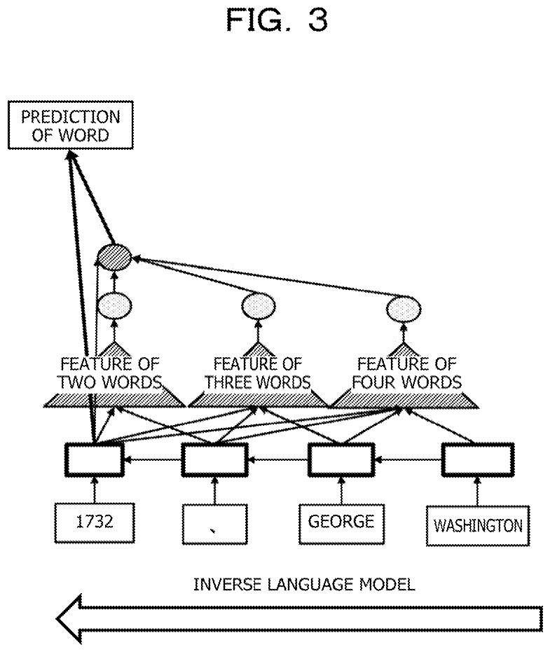

FIG. 3 is a diagram exemplifying an inverse language model in the information processing apparatus 1 as an example of the embodiment.

The example illustrated in FIG. 3 illustrates processing in an inverse direction mode in which the plurality of words selected in an inverse direction from the end to the beginning of the text is combined to generate the compound word vector.

With only the forward language model, it is not possible to consider a compound word of the word in the beginning, and thus, it is desirable to use the inverse language model as well. By using the bidirectional language model, even a language model that predicts a masked word such as Bidirectional Encoder Representations from Transformers (BERT) may be used.

The first parameter update unit 103 trains the language model that predicts a following word by using an expanded feature vector calculated by the first multi-word feature processing unit 102 as training data.

The first parameter update unit 103 inputs the expanded feature vector (training data) calculated by the first multi-word feature processing unit 102 to the language model, and causes the language model to predict a word following a word to be processed. Then, the first parameter update unit 103 updates parameters of the language model by using the word following the word to be processed in the input text as correct answer data.

The first parameter update unit 103 optimizes the parameters by updating the parameters of the neural network in a direction for decreasing a loss function that defines an error between an inference result of the language model for the training data and the correct answer data by using, for example, a gradient descent method.

The second training processing unit 200 performs training (machine learning) of an information extraction model.

The information extraction model is, for example, a machine learning model that extracts information regarding a word based on the word included in an input text. The information extraction model predicts (estimates), for example, whether or not a plurality of words included in the text is a proper noun.

As illustrated in FIG. 1, the second training processing unit 200 includes a second word processing unit 201, a second multi-word feature processing unit 202, and a second parameter update unit 203.

Information extraction training data is input to the second training processing unit 200. The information extraction training data is a text including a plurality of words. The information extraction training data may be different from input data input to the first training processing unit 100.

The information extraction training data includes words and correct answer data (correct answer label). The correct answer label may be, for example, information indicating whether or not a corresponding word is a proper noun. The information extraction training data is second training data.

The second word processing unit 201 inputs a word constituting the information extraction training data to a language model trained by the first training processing unit 100 to cause the language model to predict (estimate) a (next) word following the word.

The second word processing unit 201 sequentially predicts a word following each word by sequentially inputting a plurality of words constituting the information extraction training data to the language model.

Similarly to the first word processing unit 101, the second word processing unit 201 vectorizes each predicted word by using, for example, the LSTM network.

The second multi-word feature processing unit 202 calculates a feature vector of a compound word obtained by combining a plurality of consecutive words in the text based on a value obtained by vectorizing each word calculated by the second word processing unit 201.

The second multi-word feature processing unit 202 may generate the respective compound word vectors with a plurality of types of the number of words by using a method similar to that of the first multi-word feature processing unit 102.

Furthermore, the second multi-word feature processing unit 202 calculates an expanded feature vector of a word to be processed by obtaining an inner product of the calculated compound word vector with each number of words and a feature vector of the word to be processed.

In the second training processing unit 200, an internal representation of the compound word is used in addition to the word at the time of extracting a proper noun in the information extraction model.

The second parameter update unit 203 trains the information extraction model by using an expanded feature vector calculated by the second multi-word feature processing unit 202 as training data.

The second parameter update unit 203 trains the information extraction model by using the expanded feature vector calculated by the second multi-word feature processing unit 202 as the training data and using a correct answer label included in the information extraction training data as correct answer data.

For example, the second parameter update unit 203 inputs the expanded feature vector calculated by the second parameter update unit 203 to the information extraction model, and causes the information extraction model to predict, for example, whether or not a corresponding word is a proper noun. Then, the second parameter update unit 203 updates parameters of the information extraction model based on a prediction result and the correct answer label included in the information extraction training data.

The second parameter update unit 203 optimizes the parameters by updating parameters of the neural network in a direction for decreasing a loss function that defines an error between an inference result of the information extraction model for the training data and the correct answer data by using, for example, the gradient descent method.

### (B) Operation

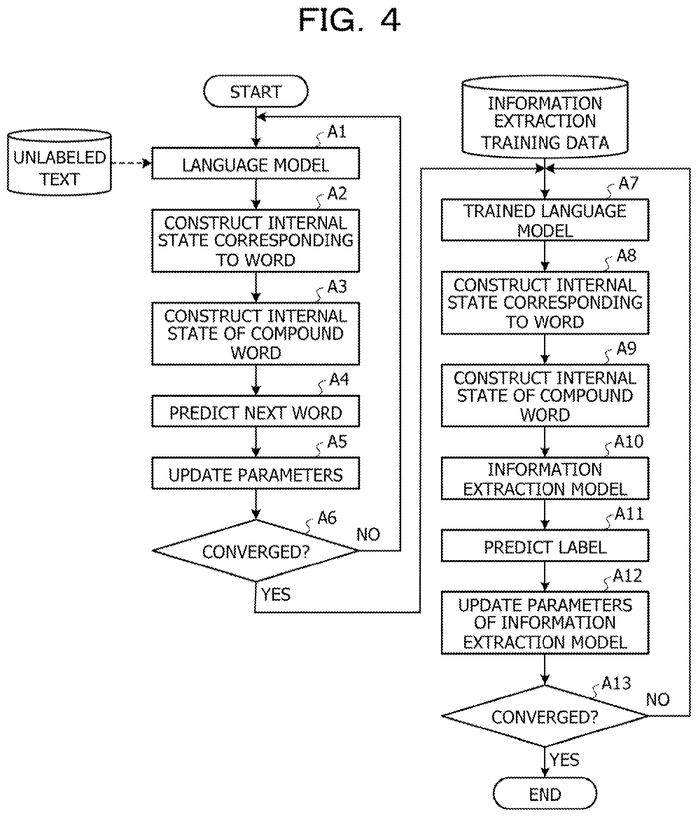

A method of training the machine learning model in the information processing apparatus 1 as an example of the embodiment configured as described above will be described with reference to a flowchart (Steps A1 to A13) illustrated in FIG. 4.

In the flowchart illustrated in FIG. 4, Steps A1 to A6 indicate processing (preliminary training processing) by the first training processing unit 100, and Steps A7 to A13 indicate processing (information extraction processing) by the second training processing unit 200.

In Step A1, the first word processing unit 101 inputs a word constituting the input text to the language model to cause the language model to predict a (next) word following the word.

In Step A2, the first word processing unit 101 vectorizes each predicted word by using, for example, the LSTM network. For example, the first word processing unit 101 constructs an internal state corresponding to the word.

In Step A3, the first multi-word feature processing unit 102 calculates a compound word vector obtained by combining a plurality of consecutive words in the text based on a value obtained by vectorizing each word calculated by the first word processing unit 101. For example, the first multi-word feature processing unit 102 constructs an internal state of a compound word.

In Step A4, the first parameter update unit 103 inputs an expanded feature vector calculated by the first multi-word feature processing unit 102 to the language model used in Step A1, and causes the language model to predict a word following a word to be processed.

In Step A5, the first parameter update unit 103 updates parameters of the language model by using the word following the word to be processed in the text as correct answer data.

In Step A6, the first parameter update unit 103 determines whether training of the language model has converged. For example, the first parameter update unit 103 may determine that the training of the language model has converged in a case where a prediction result of the language model has reached predetermined accuracy or in a case where the number of times of the training has reached a prescribed number of epochs.

In a case where the training of the language model has not converged (see a NO route in Step A6), the processing returns to Step A1. On the other hand, in a case where the training of the language model has converged (see a YES route in Step A6), the processing proceeds to Step A7.

In Step A7, the second word processing unit 201 inputs a word constituting the text of the information extraction training data to the language model trained in Steps A1 to A6 to cause the language model to predict a (next) word following the word.

In Step A8, the second word processing unit 201 vectorizes each predicted word by using, for example, the LSTM network. For example, the second word processing unit 201 constructs an internal state corresponding to the word.

In Step A9, the second multi-word feature processing unit 202 calculates a compound word vector obtained by combining a plurality of consecutive words in the text based on a value obtained by vectorizing each word calculated by the second word processing unit 201. For example, the second multi-word feature processing unit 202 constructs an internal state of a compound word.

In Step A10, the second parameter update unit 203 trains the information extraction model by using an expanded feature vector calculated by the second multi-word feature processing unit 202 as training data and using a correct answer label included in the information extraction training data as correct answer data.

In Step A11, the second parameter update unit 203 inputs the expanded feature vector calculated by the second multi-word feature processing unit 202 to the information extraction model, and causes the information extraction model to predict, for example, whether or not a corresponding word is a proper noun.

In Step A12, the second parameter update unit 203 updates parameters of the information extraction model based on a prediction result acquired in Step A11 and the correct answer label included in the information extraction training data.

In Step A13, the second parameter update unit 203 determines whether training of the information extraction model has converged. For example, the second parameter update unit 203 may determine that the training of the information extraction model has converged in a case where the prediction result of the information extraction model has reached predetermined accuracy or in a case where the number of times of the training has reached a prescribed number of epochs.

In a case where the training of the information extraction model has not converged (see a NO route in Step A13), the processing returns to Step A7. On the other hand, in a case where the training of the information extraction model has converged (see a YES route in Step A13), the processing ends.

### (C) Effect

In this way, according to the information processing apparatus 1 as an example of the embodiment, in the preliminary training processing by the first training processing unit 100, the first multi-word feature processing unit 102 calculates a compound word vector based on a plurality of words that continuously appear in a text. Then, the first multi-word feature processing unit 102 calculates a feature vector of a compound word obtained by combining the plurality of consecutive words in the text. With this configuration, an influence of ambiguity of the compound word in the second training processing unit 200 may be reduced. For example, the word “Washington” may be a place name, but it is possible to correctly determine “Washington” as a person's name by considering the compound word “George Washington”.

Furthermore, also in the information extraction processing by the second training processing unit 200, the second multi-word feature processing unit 202 calculates a compound word vector based on a plurality of words that continuously appear in the text. Then, the second multi-word feature processing unit 202 calculates a feature vector of a compound word obtained by combining the plurality of consecutive words in the text. With this configuration as well, the influence of the ambiguity of the compound word in the second training processing unit 200 may be reduced.

In the first multi-word feature processing unit 102, it is not needed to completely construct a syntax tree by directly incorporating the compound word into training of the language model. Since the compound word is only constructed automatically, an influence of an error is less than that in the case of completely constructing the syntax tree.

When the method according to the present information processing apparatus 1 is compared with a model not considering a compound word, an F-score is improved by 0.08 points in benchmark data in a public domain, and performance is improved in all eight types of benchmark data in a chemical domain. For example, in the preliminary training processing by the first training processing unit 100, the first multi-word feature processing unit 102 calculates the compound word vector based on the plurality of words that continuously appear in the text, thereby improving the performance in the information extraction processing.

### (D) Others

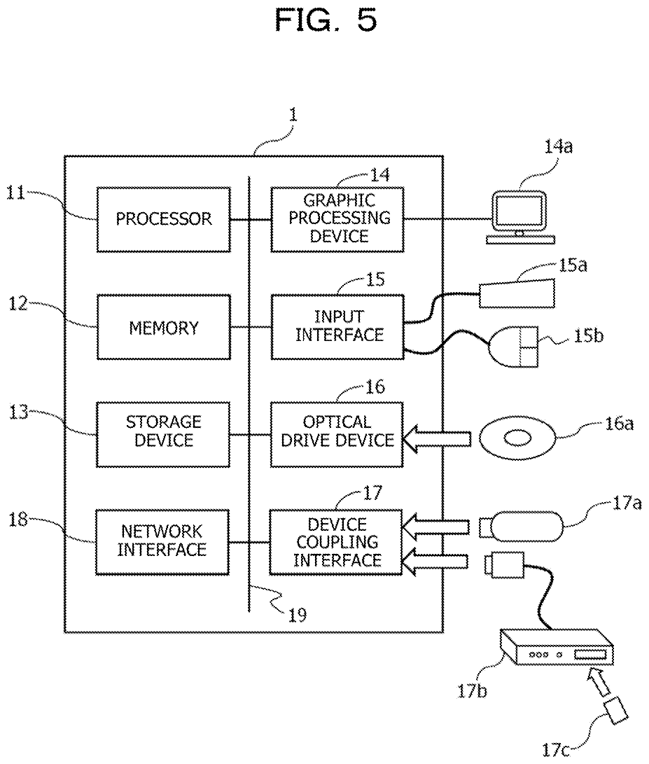

FIG. 5 is a diagram exemplifying a hardware configuration of the information processing apparatus 1 as an example of the embodiment.

The information processing apparatus 1 includes, for example, a processor 11, a memory 12, a storage device 13, a graphic processing device 14, an input interface 15, an optical drive device 16, a device coupling interface 17, and a network interface 18 as components. These components 11 to 18 are configured to be communicable with each other via a bus 19.

The processor (processing unit) 11 controls the entire information processing apparatus 1. The processor 11 may be a multiprocessor. The processor 11 may be, for example, any one of a central processing unit (CPU), a micro processing unit (MPU), a digital signal processor (DSP), an application specific integrated circuit (ASIC), a programmable logic device (PLD), a field programmable gate array (FPGA), and a graphics processing unit (GPU). Furthermore, the processor 11 may be a combination of two or more types of elements of the CPU, MPU, DSP, ASIC, PLD, FPGA, and GPU.

Then, by executing a control program (a machine learning program, a generation program, and a prediction program: all are not illustrated) by the processor 11, functions as the first training processing unit 100 and the second training processing unit 200 exemplified in FIG. 1 are implemented.

Note that the information processing apparatus 1 implements the functions as the first training processing unit 100 and the second training processing unit 200 by executing, for example, a program (the machine learning program, the generation program, the prediction program, and an OS program) recorded in a computer-readable non-transitory recording medium. The OS is an abbreviation for an operating system.

The program in which processing content to be executed by the information processing apparatus 1 is described may be recorded in various recording media. For example, the program to be executed by the information processing apparatus 1 may be stored in the storage device 13. The processor 11 loads at least a part of the program in the storage device 13 into the memory 12, and executes the loaded program.

Furthermore, the program to be executed by the information processing apparatus 1 (processor 11) may be recorded in a non-transitory portable recording medium such as an optical disc 16a, a memory device 17a, or a memory card 17c. The program stored in the portable recording medium may be executed after being installed in the storage device 13 under the control of the processor 11, for example. Furthermore, the processor 11 may directly read the program from the portable recording medium and execute the program.

The memory 12 is a storage memory including a read only memory (ROM) and a random access memory (RAM). The RAM of the memory 12 is used as a main storage device of the information processing apparatus 1. The RAM temporarily stores at least a part of the program to be executed by the processor 11. Furthermore, the memory 12 stores various types of data needed for processing by the processor 11.

The storage device 13 is a storage device such as a hard disk drive (HDD), a solid state drive (SSD), or a storage class memory (SCM), and stores various types of data. The storage device 13 is used as an auxiliary storage device of the information processing apparatus 1.

The storage device 13 stores the OS program, the control program, and various types of data. The control program includes the machine learning program, the generation program, and the prediction program.

Furthermore, the memory 12 and the storage device 13 may store each value of a feature vector calculated by the first word processing unit 101 or the second word processing unit 201 and a value of each compound word vector calculated by the first multi-word feature processing unit 102 or the second multi-word feature processing unit 202. Furthermore, each parameter calculated by the first parameter update unit 103 or the second parameter update unit 203 may be stored in the memory 12 or the storage device 13.

Note that a semiconductor storage device such as an SCM or a flash memory may be used as the auxiliary storage device. Furthermore, redundant arrays of inexpensive disks (RAID) may be configured by using a plurality of the storage devices 13.

The graphic processing device 14 is coupled to a monitor 14a. The graphic processing device 14 displays an image on a screen of the monitor 14a in accordance with a command from the processor 11. Examples of the monitor 14a include a display device using a cathode ray tube (CRT), a liquid crystal display device, and the like.

The input interface 15 is coupled to a keyboard 15a and a mouse 15b. The input interface 15 transmits signals sent from the keyboard 15a and the mouse 15b to the processor 11. Note that the mouse 15b is an example of a pointing device, and another pointing device may also be used. Examples of the another pointing device include a touch panel, a tablet, a touch pad, a track ball, and the like.

The optical drive device 16 reads data recorded in the optical disc 16a by using laser light or the like. The optical disc 16a is a non-transitory portable recording medium having data recorded in a readable manner by reflection of light. Examples of the optical disc 16a include a digital versatile disc (DVD), a DVD-RAM, a compact disc read only memory (CD-ROM), a CD-recordable (R)/rewritable (RW), and the like.

The device coupling interface 17 is a communication interface for coupling a peripheral device to the information processing apparatus 1. For example, the device coupling interface 17 may be coupled to the memory device 17a and a memory reader/writer 17b. The memory device 17a is a non-transitory recording medium equipped with a communication function with the device coupling interface 17, for example, a universal serial bus (USB) memory. The memory reader/writer 17b writes data to the memory card 17c or reads data from the memory card 17c. The memory card 17c is a card-type non-transitory recording medium.

The network interface 18 is coupled to a network. The network interface 18 transmits and receives data via the network. Another information processing apparatus, communication device, or the like may be coupled to the network.

Each configuration and each processing of the present embodiment may be selected or omitted as needed or may be appropriately combined.

Additionally, the disclosed technology is not limited to the embodiment described above, and various modifications may be made and performed in a range without departing from the spirit of the present embodiment.

For example, in the example illustrated in FIG. 2, the first multi-word feature processing unit 102 calculates the feature vectors of two words, three words, and four words, but the disclosed technology is not limited to this. The first multi-word feature processing unit 102 may calculate a feature vector of five or more words. Furthermore, similarly, the second multi-word feature processing unit 202 may calculate a feature vector of five or more words.

Furthermore, in the embodiment described above, an example has been indicated in which the first multi-word feature processing unit 102 generates a compound word vector in the bidirectional language model in each of the forward direction mode and the inverse direction mode, but the disclosed technology is not limited to this. The first multi-word feature processing unit 102 may use only at least one of the forward language model and the inverse language model. Furthermore, the second multi-word feature processing unit 202 may also use only at least one of the forward language model and the inverse language model.

Moreover, in the embodiment described above, the information processing apparatus 1 includes the functions as the first training processing unit 100 and the second training processing unit 200, but the disclosed technology is not limited to this. For example, the function as one of the first training processing unit 100 and the second training processing unit 200 may be implemented in another information processing apparatus coupled to the information processing apparatus 1 via a network.

Furthermore, the information processing apparatus 1 may include another function in addition to the functions as the first training processing unit 100 and the second training processing unit 200. For example, the information processing apparatus 1 may include a prediction function of performing prediction on document data by using the information extraction model trained by the second training processing unit 200, and the prediction function may be appropriately changed and performed.

Furthermore, the present embodiment may be performed and manufactured by those skilled in the art according to the disclosure described above.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a generation program for causing a computer to execute processing comprising:
generating a feature vector of each of a plurality of words based on document data that includes the plurality of words; and
generating a feature vector of a compound word obtained by combining two or more words based on the generated feature vector of each of the plurality of words,
wherein the feature vector of each of the plurality of words and the feature vector of the compound word are used to predict a word that follows one word in the document data.

2. The non-transitory computer-readable recording medium according to claim 1, for causing the computer to execute the processing further comprising constituting the compound word by words with a plurality of types of the number of combinations.

3. The non-transitory computer-readable recording medium according to claim 1, wherein the processing of generating the feature vector of the compound word includes
processing performed in a forward direction mode in which the plurality of words selected in a forward direction from beginning to end of the document data is combined to generate the feature vector of the compound word or an inverse direction mode in which the plurality of words selected in an inverse direction from the end to the beginning of the document data is combined to generate the feature vector of the compound word or any combination of the forward direction mode or the inverse direction mode.

4. A non-transitory computer-readable recording medium storing a prediction program for causing a computer to execute processing comprising predicting, by using a feature vector of each of a plurality of words generated based on document data that includes the plurality of words, and a feature vector of a compound word obtained by combining two or more words generated based on the feature vector of each of the plurality of words, a word that follows one word in the document data.

5. The non-transitory computer-readable recording medium according to claim 4, for causing the computer to execute the processing further comprising constituting the compound word by words with a plurality of types of the number of combinations.

6. The non-transitory computer-readable recording medium according to claim 4, wherein the processing of generating the feature vector of the compound word includes
processing performed in a forward direction mode in which the plurality of words selected in a forward direction from beginning to end of the document data is combined to generate the feature vector of the compound word or an inverse direction mode in which the plurality of words selected in an inverse direction from the end to the beginning of the document data is combined to generate the feature vector of the compound word or any combination of the forward direction mode or the inverse direction mode.

7. An information processing apparatus comprising:
a memory; and
a processor couple to the memory and configured to:
generate a feature vector of each of a plurality of words based on document data that includes the plurality of words; and
generate a feature vector of a compound word obtained by combining two or more words based on the generated feature vector of each of the plurality of words,
wherein the feature vector of each of the plurality of words and the feature vector of the compound word are used to predict a word that follows one word in the document data.

8. The information processing apparatus according to claim 7, wherein the processor constitutes the compound word by words with a plurality of types of the number of combinations.

9. The information processing apparatus according to claim 7, wherein the processor generates the feature vector of the compound word in a forward direction mode in which the plurality of words selected in a forward direction from beginning to end of the document data is combined to generate the feature vector of the compound word or an inverse direction mode in which the plurality of words selected in an inverse direction from the end to the beginning of the document data is combined to generate the feature vector of the compound word or any combination of the forward direction mode or the inverse direction mode.
